(19) United States
(12) Patent Application Publication
(10) Pub. No.: US 2024/0308540 A1
(43) Pub. Date: Sep. 19, 2024

(54) YIELD PREDICTION MODEL TO COMPUTE AUTONOMOUS VEHICLE TRAJECTORIES

(71) Applicant: GM Cruise Holdings LLC, San Francisco, CA (US)

(72) Inventors: Can Cui, San Francisco, CA (US); Prathyush Katukojwala, Pasadena, CA (US); Fei Gao, Sunnyvale, CA (US)

(21) Appl. No.: 18/183,040

(22) Filed: Mar. 13, 2023

(51) Int. Cl. B60W 60/00

(52) U.S. Cl. CPC B60W 60/001; B60W 2554/4029; B60W 2556/10; B60W 2556/40

(57) ABSTRACT

The present disclosure generally relates to autonomous vehicle (AV) navigation and, more specifically, to improving AV determinations regarding when to yield to other vehicles (entities) in various driving scenarios. In some aspects, a process of the disclosed technology includes steps for receiving road data comprising sensor data collected by an autonomous vehicle (AV), extracting trajectory data from the road data, for each of the one or more entities, and providing the trajectory data to a machine-learning (ML) model, wherein the ML model is trained to generate a yield prediction for each of the one or more entities. In some aspects, the process can further include steps for determining a path for the AV based on the yield prediction for each of the one or more entities. Systems and machine-readable media are also provided.

### BACKGROUND

### 1. Technical Field

The present disclosure generally relates to autonomous vehicle (AV) navigation and, more specifically, to improving AV determinations regarding when to yield to other vehicles (entities) in various driving scenarios.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as perception, planning, and navigation. For example, the sensors can provide the data and measurements to a computing system of the autonomous vehicle, which can use the data and measurements to facilitate the control of various mechanical systems, such as a vehicle propulsion system, a braking system, or a steering system, and the like.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example environment in which an AV can make assert/yield decisions with respect to one or more other entities (e.g., road vehicles), according to some examples of the present disclosure.

FIG. 2 illustrates an example system that can be used to facilitate the preparation of training data used to train a machine-learning model, e.g., to perform yield and/or assert predictions, and to evaluate the performance of an AV planning module, according to some examples of the present disclosure.

FIGS. 3A and 3B illustrate example systems that can be used for training and deploying a machine-learning model configured to generate yield/assert predictions, according to some examples of the present disclosure.

FIG. 4 illustrates an example system that is configured for evaluating performance of a machine-learning model configured to generate yield/assert predictions, according to some examples of the present disclosure.

FIG. 5 illustrates an example process for using yield (or assert) predictions made by a machine-learning model to improve AV planning operations, according to some aspects of the present disclosure.

FIG. 6 illustrates an example process for evaluating the performance of an AV planning module using yield (or assert) predictions made by a machine-learning model, according to some aspects of the present disclosure.

FIG. 7 illustrates an example process for evaluating the performance of a machine-learning model that is configured to generate yield/assert predictions, based on resulting AV behaviors, according to some aspects of the present disclosure.

FIG. 8 illustrates an example of a deep learning neural network that can be used to implement an assert/yield prediction model, according to some aspects of the disclosed technology.

FIG. 9 illustrates an example system environment that can be used to facilitate autonomous vehicle (AV) dispatch and operations, according to some aspects of the disclosed technology.

FIG. 10 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Some aspects of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

Autonomous vehicles (AVs) utilize a variety of software modules to perceive and reason about the environments in which they navigate. In some AV deployments, the AV software (or AV software stack) can include modules (or layers) to perform perception, prediction, and planning. In such implementations, the perception layer can be responsible for receiving sensor data and, using the sensor data, identifying the locations and types of objects in the surrounding environment. Object identification can include the identification of static objects, such as buildings, road signs, and/or topographical features (e.g., roadways, cross walks, parking areas, etc.), as well as the identification of dynamic objects, such as various roadway entities, such as vehicles, and pedestrians, etc. Objects, such as variously encountered entities, identified by the perception layer can be output to downstream modules/layers, such as the prediction layer and/or the planning layer.

In some implementations, the prediction layer (or prediction module) is responsible for estimating/predicting object trajectories or locations at future times. For example, the prediction module can be configured to predict trajectories for various other entities (e.g., vehicles or other traffic participants) encountered by the AV and represented in the collected sensor data or road data. As used herein, road data can refer to all data collected (recorded) by an AV during operation, including map metadata, sensor data, weather data, and various other types of data accessed, collected or received by the AV during its operation. Depending on the desired implementation, trajectory predictions for a given entity can be represented as location estimates for the entity at discrete future time points. For example, trajectories for each entity can be computed at 0.50 sec intervals for up to 9 sec into the future. However, it is understood that other time intervals (e.g., 0.25 sec, 0.125 sec, etc.) or future projected time periods (e.g., 18 sec, 30 sec, etc.), may be used without departing from the scope of the disclosed technology.

The predicted entity trajectories can be used by the planning layer (or planning module) to determine an optimal path for the AV through the environment. Path selection (also referred to herein as route selection) can be based on multiple constraints, including but not limited to computed metrics for passenger safety, comfort, and/or route efficiency, etc. In some approaches, multiple possible paths (or path plans) for the AV may be computed, where each path can be associated with cost metrics that account for the variously associated factors, such as safety, comfort, and/or efficiency, etc. Path selection can then be performed by selecting a route (from among multiple path plans) that is associated with the lowest cost, e.g., to ensure maximal rider safety, comfort and/or overall satisfaction. By way of example, when evaluating two path plans, the planning module may select the plan that is associated with the lowest safety cost (or the highest safety score); that is, the AV planning module may preferentially select navigation routes with higher probabilities of passenger safety.

One difficulty in optimizing AV route planning is that the planning module may sometimes incorrectly project when the AV will yield to other entities at various future times. For example, the planning module may select a route plan in which the AV's trajectory overlaps that of another entity, such as another traffic participant. When trajectory overlap is expected, the planning module can project which entity will yield (or conversely which should assert) upon approaching the overlapping location (also referred to herein as a conflict region or conflict zone). In many AV implementations, the assert/yield projection made by the AV's planning module is based on a time of arrival, wherein the first arriving vehicle is assumed to assert, and the subsequently arriving vehicle is assumed to yield. For example, it may be estimated that an AV and another entity will arrive at a conflict region at some future time. In such cases, the planning module may project that the other entity will yield if it arrives later in time; as such, the AV's trajectory plan may register an intent to assert (not to yield) upon approaching the conflict region. In other cases, the AV planning module may estimate that the AV will arrive at the conflict region at a later time with respect to the other entity, in which case it may project that the other entity will assert (and not yield to the AV) upon approaching the conflict region. However, using arrival order to project assert/yield behavior can be inaccurate in many scenarios.

Because yield/assert projections made by the planning module are factored into cost metrics used to select with a chosen route plan, incorrect projections can be especially problematic. For example, a potential AV route that incorrectly projects yielding by another entity may be more dangerous than originally estimated (e.g., due to the incorrect yielding projection) and thereby carry a larger associated safety cost than estimated when the route was initially selected. That is, incorrect yield/assert projections made by the planning module can result in the selection of sub-optimal routes/paths by the AV.

Aspects of the disclosed technology provide solutions for identifying instances in which incorrect yield/assert projections have been made by the AV planning module, e.g., in legacy AV road data, and for using such instances to mine training data that can be used to train a novel yield/assert prediction model. The yield prediction model can be a machine-learning model that is configured (trained) to predict a likelihood that a given entity will yield to the AV (or assert) when arriving at a conflict region. Once trained, the yield prediction model can be deployed on an AV and used to predict likelihoods that various entities in an environment will yield (or not yield) to the AV at future times. Estimates from the yield prediction model can be validated against yield/assert projections made by the planning model (e.g., that are based on a first-in-time heuristic) and used to determine if the respective yield/assert predictions conflict. In instances where yield/assert projections from the planning module conflict with yield/assert predictions made by the yield prediction model, corresponding path plans can be penalized, e.g., by increasing the associated costs of those plans to reduce the likelihood that the AV will select those paths for navigation.

In some aspects, the trained yield prediction model can be used to evaluate planner performance. For example, by using the trained yield prediction model to make yield (and/or assert) predictions using legacy road data (e.g., recorded data previously collected by one or more AVs), the outputs of the yield prediction model can be used to identify instances where the planning model incorrectly (or correctly) projected a yield/assert instance. In this way, the yield prediction model can be used to identify conditions under which performance of the planning module may be improved.

Additionally, in some aspects, AV performance (behavior) may be used to evaluate the performance of the yield prediction model. For example, instances in which planning model projections and predictions of the yield prediction model are in conflict can be used to update costs associated with a given route plan. However, changes to associated costs may not always translate into corresponding changes in AV path selection. By using (legacy) road data to evaluate how utilization of the yield prediction model resulted in changes to the AV's trajectory, AV behaviors can be used to validate the efficacy of yield prediction model deployments.

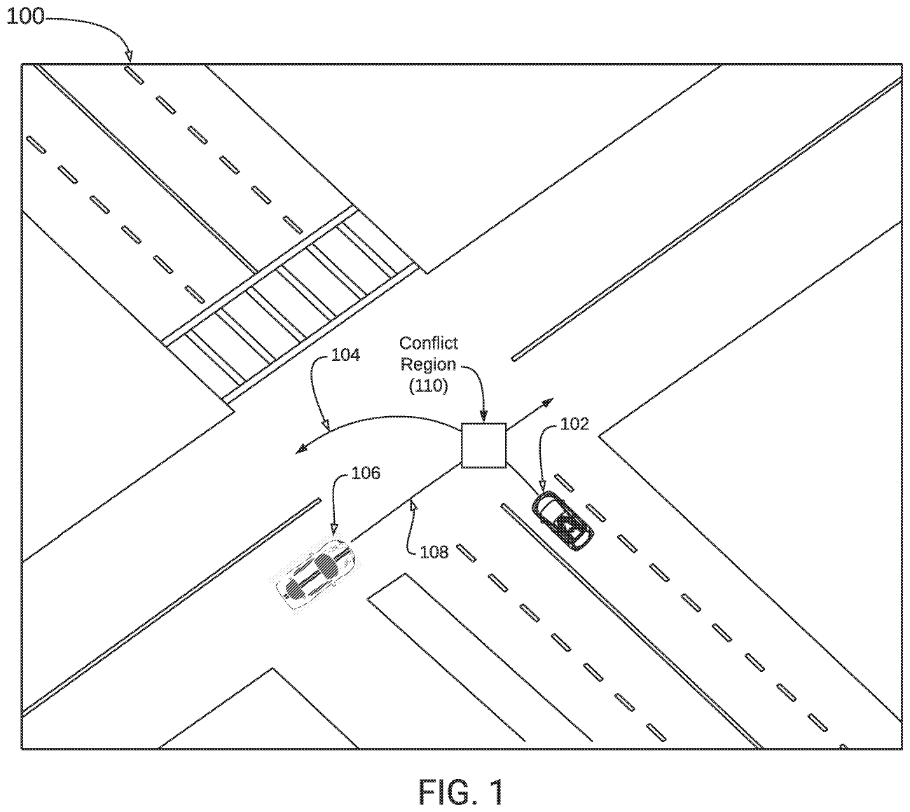

FIG. 1 illustrates an example environment 100 in which an autonomous vehicle (AV) 102 can be configured to make routing decisions based on a likelihood of yielding to one or more other entities, such as road vehicle 106. In the example of FIG. 1, AV 102 has selected a route plan to cause AV 102 to navigate along trajectory 104. Trajectory 104 can be determined/selected by a planning module (or planning layer) of the AV's software stack. For example, trajectory 104 may represent an optimal path through environment 100, taking into consideration metrics for safety, comfort, and/or efficiency, etc. As discussed above, the planning module of AV 102 can also be configured to project/estimate trajectories for other entities in environment 100, such as trajectory 108 for vehicle 106.

In some instances, trajectories for two or more entities may overlap, indicating that the entities will arrive at the same approximate location at the same approximate time. For example, trajectory 104 of AV 104 intersects trajectory 108 of vehicle 106, which is indicated by conflict region 110. In some implementation, a conflict region (e.g., conflict region 110) can indicate a location (and time) where only one vehicle can assert (i.e., stay its original course without yielding to other vehicles/entities), whereas other vehicles arriving at the conflict region must yield, e.g., to avoid a collision. In some AV implementations, the AV planning module (such as the planning module of AV 102) can project which entity should yield based on arrival time. Further to the example of FIG. 1, if vehicle 106 arrives at conflict region 110 at a time that is later than the arrival time of AV 102, the planning module may project that vehicle 106 will yield to AV 102. However, in instances where driving context does not dictate that vehicle 106 should yield, such as when vehicle 106 is on a straight road path, and AV 102 is attempting a left-turn maneuver, and in the example of FIG. 1, projections made by the AV planning module may incorrectly estimate the behavior of the other entity (e.g., vehicle 106).

In practice, road data captured by AV 102 during the course of its driving operations can record instances where yield/assert projections made by the planning module are incorrect. Such instances may be indicated in collected road data in multiple ways. For example, the road data may record conflict region instances, projections of the planning module (e.g., yield/assert projections for other entities), and/or take-over events, e.g., where a technician or AV operator assumes control of the AV to override the originally planned maneuver attempt. By way of example, road data collected by AV 102 may record data representing identified conflict zones, an original trajectory plan (e.g., to follow trajectory 104), planner intent, e.g., to assert or yield, and/or actual AV behavior, e.g., how the AV responded or was maneuvered (e.g., by a technician) around/through the conflict zone. As discussed in further detail below, such events recorded in road data may be used to identify on-road events or driving scenarios that may be used to train a novel machine-learning model (e.g., a yield prediction model), for example, to more accurately predict when variously encountered entities are likely to assert or yield when approaching a particular conflict region.

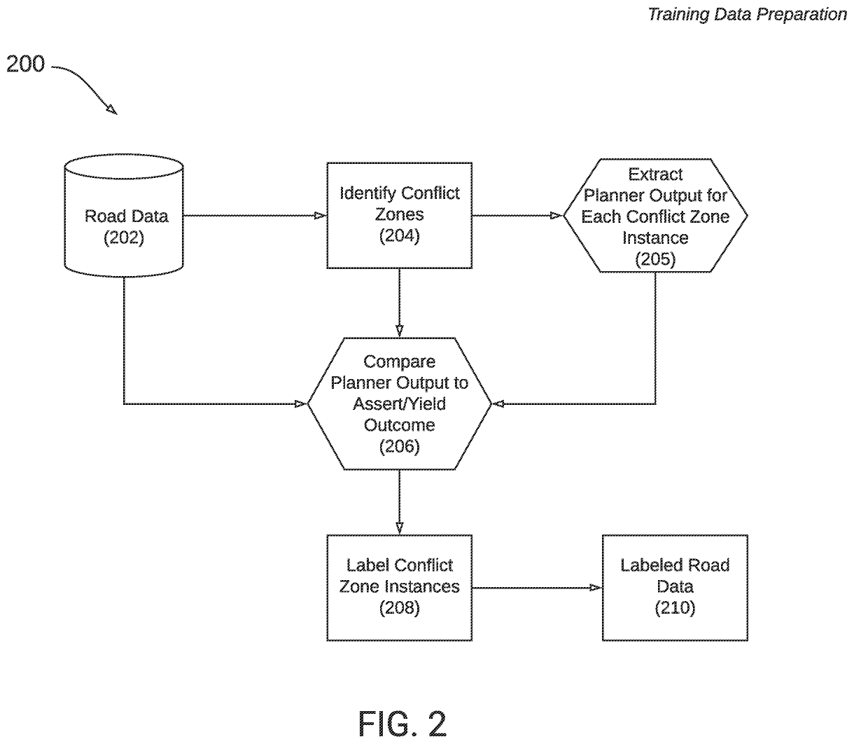

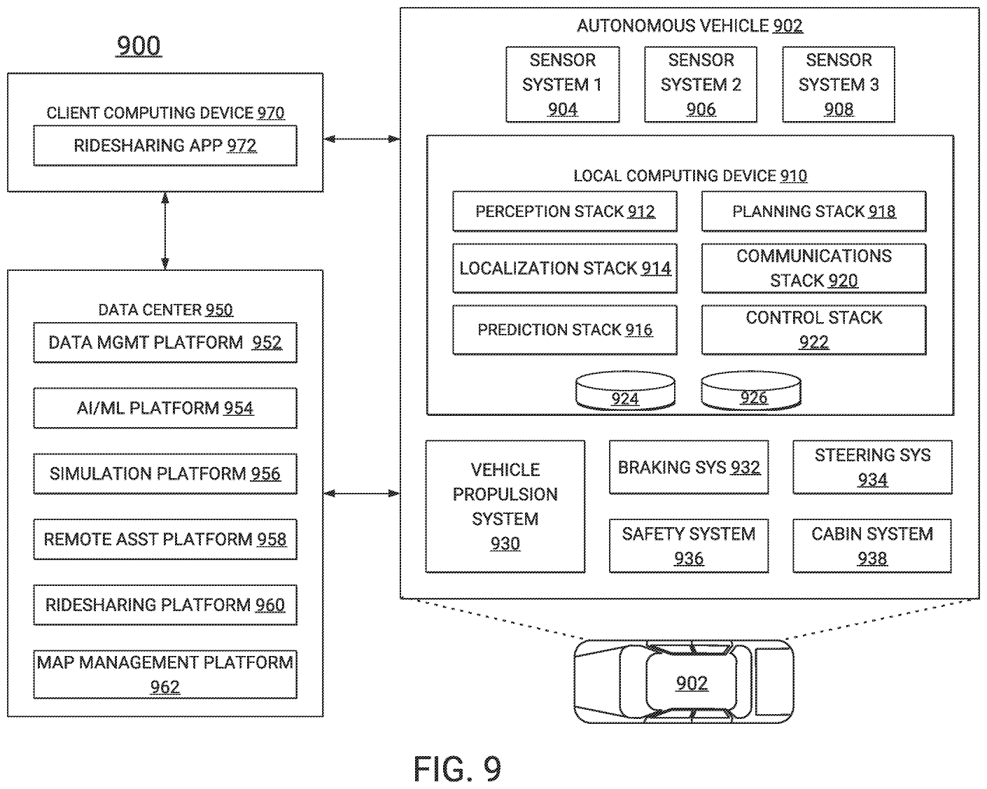

FIG. 2 illustrates an example system 200 that can be used to facilitate the preparation of training data used to train a machine-learning model (e.g., a yield prediction model), to perform yield and/or assert predictions. As discussed above, training data may be collated from collections of road data 202, that may include data collected by one or more AVs during the course of driving operations. As such, road data 202 can include various types of sensor data, such as data from one or more Light Detection and Ranging (LiDAR) sensors, Radio Detection and Ranging (RADAR) sensors, camera sensors, Inertial Measurement Units (IMU)s, accelerometers, gyroscopic sensors, and/or ultrasonic sensors, and the like. Road data can also include map data, data received from third-party sources, and/or data that is collected using systems/telemetry outside of the AV, such as satellite localization systems. Additionally, road data can include any information derived or determined by the AV during the course of operation, such as determinations/calculations made from any of the AV's software sub-systems, including but not limited to results generated by the perception module, prediction module, planning module, and/or the control module. Further details regarding various AV systems that can be used to facilitate navigation and planning operations are provided in discussion with respect to FIG. 9, below.

Using road data 202, conflict zones from past AV operations can be identified. Depending on the desired implementation, the conflict zones may be identified from road data collected by a single AV, or multiple AVs. Each of the identified conflict zones (204) can indicate an instance where a trajectory of an AV intersected with that of another entity, such as that illustrated in the example of FIG. 1. Identified conflict zone instances can be used to identify times/locations, as well as other AV metadata, at a time when the recording AV made an assert/yield decision. For example, the identified conflict zones can be used to parse (or mine) road data 202 to further identify the projection of the AV planner for a given conflict instance (205). Further to the example discussed above with respect to FIG. 1, for the conflict instance represented by conflict region 110, the planning module of AV 102 may project that vehicle/entity 106 will yield, due to its later arrival at conflict region 110. Once the planner intent has been identified for a given conflict instance (205) the planner output can be compared to the actual assert/yield outcome experience by the AV (206). Again referring to the example of FIG. 1, entity 106 may not yield to AV 102 (as projected by the planning module), and instead a technician may override AV navigation such that the AV is forced to yield to entity 106.

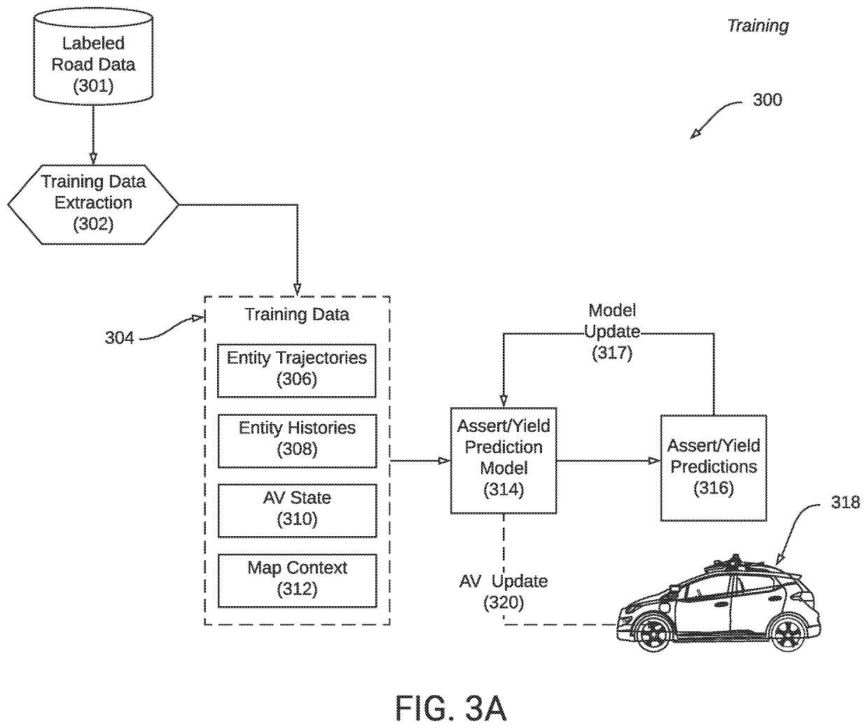

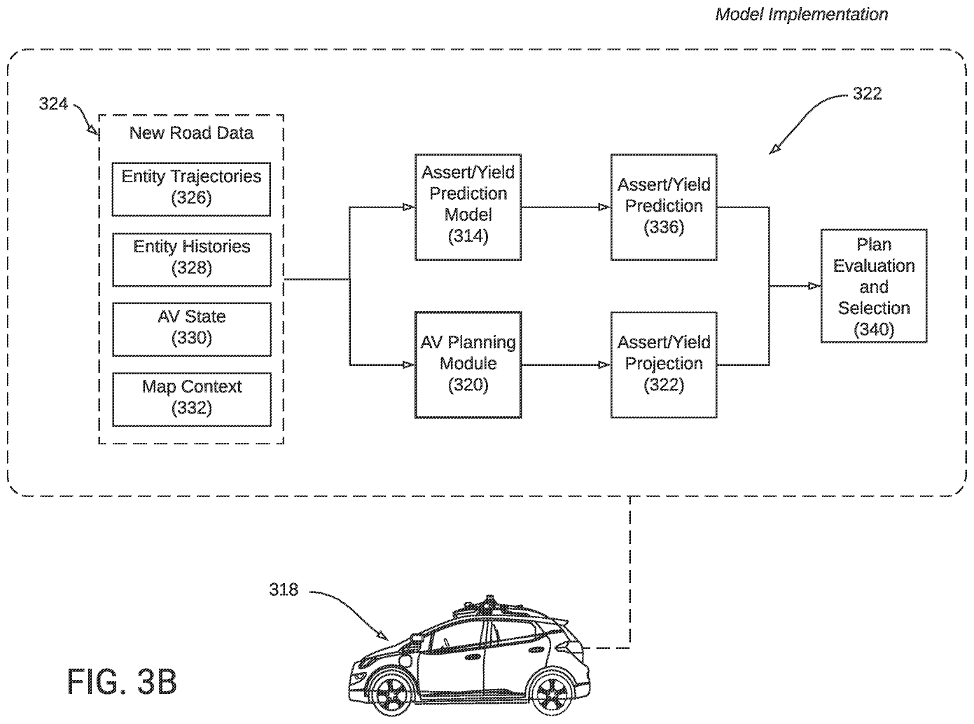

In scenarios where the planner output (e.g., the planner's yield/assert projection) conflicts with the resulting AV behavior, conflict zone occurrences can be labeled (block 208) for further examination and processing. For example, labeled conflict zone occurrences can be used to generate labeled road data 210 that can be used to facilitate the training of a machine-learning model (e.g., a yield prediction model) that is configured to predict future yield/assert behavior by various entities in an AV's surrounding environment. Methods for training a yield prediction model are discussed in further detail with respect to FIG. 3A, below.

In particular, FIG. 3A illustrates an example system 300 that can be used for training and deploying a machine-learning model configured to generate yield/assert predictions, using labeled road data 301. In operation, system 300 can be configured to provide labeled road data 301 to a training data extraction process 302 that is configured to extract a variety of data (training data 304) that can be used for training a yield prediction model 314. Training data 304 can include entity trajectories 306, which indicates projected trajectories of one or more entities that are represented in labeled road data 301; entity histories 308, which can include any information about the behavioral/kinematic history of a given entity (e.g., vehicles encountered by the AV); AV state information 310, which can include any information about the AV, including but not limited to location information, route information, and/or information about any of the AV's hardware or software systems; and/or map context information 312, which can include any form of map data or map metadata, such locations of roadways, crosswalks, traffic lights, buildings, and/or any other map features.

The labeled training data 304 can then be provided as an input to the yield/assert prediction model 314, which is configured to make assert/yield predictions 316 with respect to different entities represented in the training data 304. Because the labeled training data contain ground truth information about actual AV behaviors (labels), the predictions made by the assert/yield prediction model 314 can be validated, and incorrect predictions penalized, and used to update various layers and/or weights the assert/yield prediction model 314 architecture. The resulting, updated/trained model can then be provided to one or more AVs 318 via an AV update process 320, and used by AV 318 to improve planning, navigation, and safety performance.

FIG. 3B illustrates an example system 322 in which a trained yield prediction model 314 is used by AV 318. When deployed, yield prediction model 314 can consume new road data 324 that is collected generated by various AV sensors and systems. In some aspects, only portions of the newly acquired road data may used by yield prediction model 314 and/or the AV planning module 320. In the example of FIG. 2B, new road data 324 can include at least information indicating entity trajectories 326, entity histories, AV state 330, and/or map context. It is understood that various other types of data may be parsed for consumption by yield prediction model 314 and/or by AV planning module 320.

Yield prediction model 314 can be configured to receive new road data 324 (e.g., in real time, or near-real time), and to output assert/yield predictions for one or more entities represented in the new road data 324. For one or more entities represented by road data 324, yield prediction model 314 can be configured to make predictions (e.g., assert yield predictions 336) about the probability that the entity will yield to the AV at a future time. For example, yield prediction model 314 can be configured to receive road data 324, and based on information for one or more of the entities represented therein (e.g., entity trajectory information 326, entity history information 328), as well as AV state information 330 and/or map context data (or map data) 332, to make predictions 336 regarding the probability that each of the one or more entities will yield (or assert) with respect to AV 318. In some implementations, yield prediction model 314 may be configured to filter out certain entities based on context and/or temporal scene characteristics, e.g. to avoid the computational cost of computing the corresponding yield/assert probabilities. For example, map context information 332 may be used to filter/remove entities that are unlikely to intersect with a trajectory of AV 318, and/or for which yield/prediction projections are not necessary.

Road data 324 can also be provided to/received by AV planning module 320, for example, that can be configured to identify potential conflict regions (i.e., map locations where AV 318 and one or more entities may occupy the same space at the same future time) to determine if AV 318 will yield at the future time. The assert/yield projections 322, generated by AV planning module 320, can be compared with the assert/yield predictions 336 that are generated by assert/yield reduction model 314, for example, to identify conflicts between the yield prediction model 314 and the AV planning model 320. In some aspects, conflicts between the yield predictions 336, and projections 322 can be used to evaluate the overall cost associated with the given trajectory plan of AV 318. For example, conflicts may be used to penalize any potential AV path plan that includes an AV trajectory that includes conflict regions but for which outputs of the yield prediction model 314, and AV planning model 320 are in disagreement. Based on the cost associated with each potential AV path plan, AV planning module 320 can perform a process for evaluating and selecting (340) a trajectory path for AV 318. By penalizing AV paths for which assert/yield predictions made by yield prediction model 314 conflict with those of AV planning module 320, the path selection process performed by AV 318 can prioritize AV paths that are associated with more accurate/consistent yield predictions.

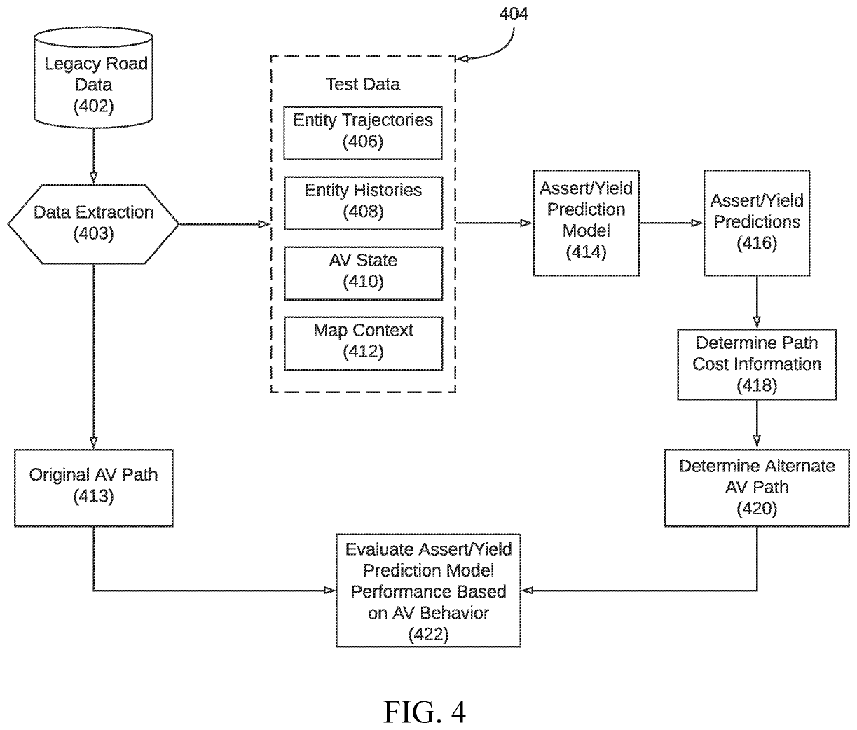

FIG. 4 illustrates an example system 400 that is configured for evaluating performance of a machine-learning model (e.g., a yield prediction model) configured to generate yield/assert predictions. As discussed in further detail below, system 400 can be used to evaluate the impact that yield/assert projections can on overall AV path selection. That is, system 400 can be used to evaluate how use of a yield prediction model would AV routing and navigation behavior. One advantage provided by system 400 is that it can provide insight as to how a yield prediction model would impact AV behavior, without the need for actually deploying the yield prediction model onto a physical AV. As such, system 400 can provide a fast, low-risk, and low cost solution for evaluating yield prediction model performance, without the need for updating AV software. By facilitating the evaluation of yield prediction model performance without the need for deployment onto operating fleet vehicles, system 400 can provide insight as to the efficacy and safety of the prediction model, without the time, expense, and safety risk of running tests on passenger-carrying vehicles.

In operation, system 400 can include an operation for collecting and receiving legacy road data 402, for example, that includes road data previously collected by one or more A Vs during the course of driving operations. The legacy road data can be parsed, via a data extraction process 403, to extract test data 404, which includes inputs that would be received by a yield prediction model 414, for example, if the yield prediction model was operating on the AV at a time that road data 402 was collected. Data extraction process 403 can also be used to parse AV plan information 413 from legacy road data 402 that represents the original AV intent for different path plans that were evaluated during at a time of AV operation. That is, original AV plan information 413 represents outputs by an AV planning module, including assert/yield projections for different AV trajectories and information indicating the chosen AV path that was selected for navigation by the AV.

In some aspects, system 400 can include a data extraction process 404 that is configured to receive road data 402, and to parse the road data 402 into data portions usable by yield prediction model 414 and to extract AV path information indicating one or more original AV paths 413 that were selected by the AV/s during operation. That is, original AV path information 413 represents actual paths/routes selected and navigated by one or more AVs represented in legacy road data 402. Test data 404 that is extracted from legacy road data 402 can include inputs required by yield prediction model 414 to make yield/assert predictions 416 for one or more entities represented therein. For example, yield prediction model can receive entity trajectory information 406, entity history information 408, as well as AV state information 410, and map context information 412, that can be used to make assert/yield predictions for each entity encounter.

The assert/yield predictions 416 can then be used to perform cost scoring for each path plan that was considered by the AV/s. For example, the assert/yield predictions 416 can be used to determine path cost metrics (418) for each path plan that was under consideration by the AV/s, e.g., as represented in legacy road data 402. Using the updated cost metric information, the selected path of the AV/s can be determined (420), and then compared to the original AV plan 413 in order to evaluate the performance of yield prediction model (414). By way of example, the original path plan 413 may indicate that an AV (represented in legacy road data 402) selected a first path, e.g., based on cost metrics that did not include accurate yield/assert projections. Using the assert/yield predictions 418 of yield prediction model 414, more accurate cost assessments for the first path can be made, and given the new (potentially greater cost) associated with the first path, the alternate AV path 420 selected by the AV may be a different path, e.g., a second path. When comparing the path selection choices (422) it can be determined that the use of yield prediction model 414 would have resulted in different behavior (e.g., a different trajectory of the AV).

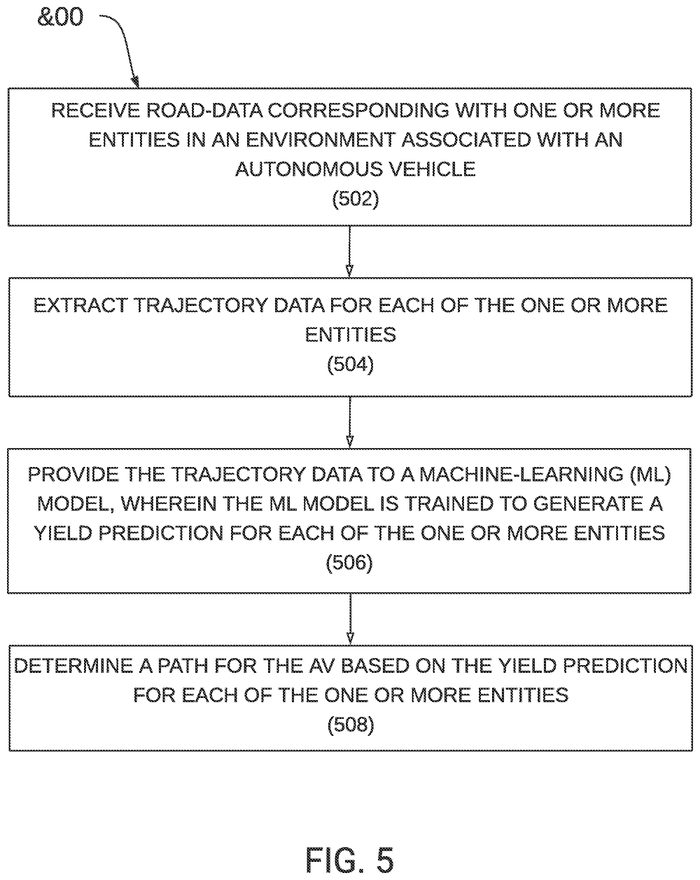

FIG. 5 illustrates an example process for using yield (or assert) predictions made by a machine-learning model (e.g., a yield prediction model) to improve AV planning operations. At step 502, process 500 includes receiving road data comprising sensor data collected by an autonomous vehicle (AV), the sensor data representing one or more entities encountered by the AV. In some aspects, only portions of the newly acquired road data may used by the yield prediction model and/or a planning module of the AV.

As such, at step 504, process 500 includes extracting trajectory data, from the road data, for each of the one or more entities. In some approaches, newly collected road data can include at least information indicating entity trajectories, entity histories, AV state information, and/or map data (map context information). It is understood that various other types of data may be parsed for consumption by yield prediction model 314 and/or by AV planning module 320.

At step 506, process 500 includes providing the trajectory data to a machine-learning (ML) model (e.g., the yield prediction model), wherein the yield prediction model is trained to generate a yield prediction for each of the one or more entities. As discussed above, yield predictions for a given entity can be estimated probabilities that the entity will yield to the AV at some future time, such as when the entity and the AV arrive at a conflict zone. In addition to the entity trajectory data, the yield prediction model can be configured to receive additional information about the entities in the environment, the AV, and/or the map context in which the AV/entity encounters occur. For example, the yield prediction model can be configured to receive entity history information (e.g., including information about historic entity locations, trajectories, and/or kinematics, etc.), AV state information (e.g., indicating various characteristics of the AV, such as location and heading information), and/or map context data (or map data), e.g., indicating features on the map, including drivable areas, undrivable areas, lane boundaries, crosswalk boundaries, etc. . . . In some implementations, certain entities or other objects may be filtered out (removed from consideration by the yield prediction model) based on context and/or temporal scene characteristics, e.g. to avoid the computational cost of computing the corresponding yield/assert probabilities. For example, map context information may be used to filter/remove entities that are unlikely to intersect with a trajectory of AV, and/or for which yield/prediction projections are unnecessary.

At step 508, process 500 includes determining a path for the AV based on the yield prediction for each of the one or more entities. Path determinations can be made based on considerations that include several cost metrics, including but not limited to safety metrics, comfort metrics, and efficiency metrics. In some aspects, conflicts between the yield prediction model and projections made by the AV's planning module can increase cost metrics (such as by increasing a safety cost metric) associated with a particular path plan. As such, the path determination for the AV (step 508) can include selection of a AV path from among multiple path plans, for example, that takes into account yield predictions from the prediction model.

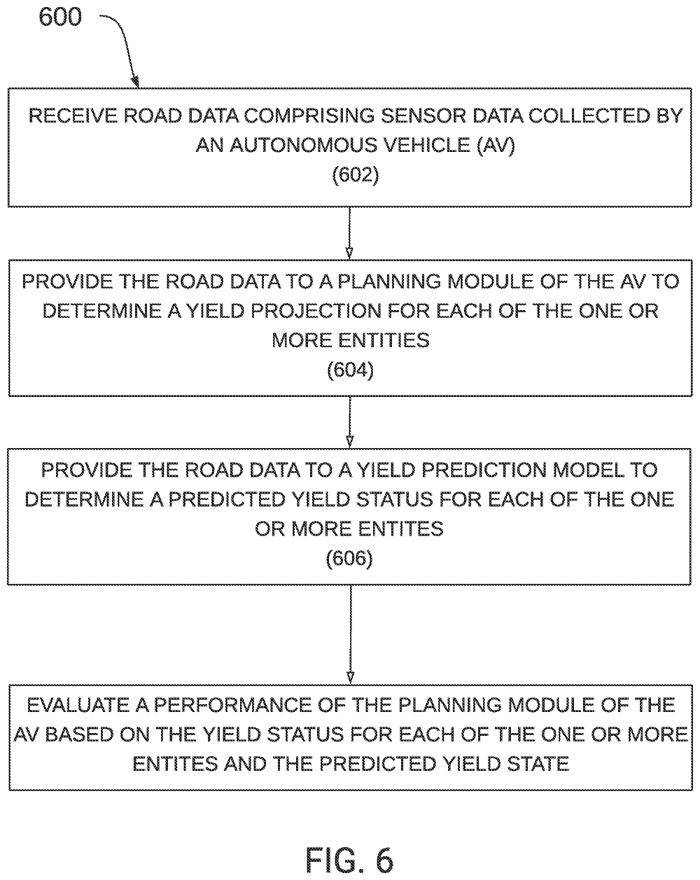

FIG. 6 illustrates an example process for evaluating the performance of an AV planning module using yield (or assert) predictions made by a machine-learning model. At step 602, process 600 includes receiving road data comprising sensor data collected by an autonomous vehicle (AV), the sensor data representing one or more entities encountered by the AV. The sensor data can include data from different sensor modality types, for example, road data can include data from one or more Light Detection and Ranging (LiDAR) sensors, Radio Detection and Ranging (RADAR) sensors, camera sensors, Inertial Measurement Units (IMU)s, accelerometers, gyroscopic sensors, and/or ultrasonic sensors, and the like. Road data can also include map data, data received from third-party sources, and/or data that is collected using systems/telemetry outside of the AV, such as satellite localization systems. Additionally, road data can include any information derived or determined by the AV during the course of operation, such as determinations/calculations made from any of the AV's software sub-systems, including but not limited to results generated by the perception module, prediction module, planning module, and/or the control module. Further details regarding various AV systems that can be used to facilitate navigation and planning operations are provided in discussion with respect to FIG. 9, below.

At step 604, process 600 includes providing the road data to a planning module of the AV to determine a yield projection for each of the one or more entities.

At step 606, process 600 includes providing the road data to a yield prediction model to determine a yield prediction for each of the one or more entities. In some aspects, the road data may be pre-processed, for example, to extract specific information components for the input layer of the yield prediction model. As discussed above, using the road data, various types of information about entities in the environment may be extracted, including but not limited to entity trajectory information, and/or entity history information. Additionally, AV state information and map context information may be extracted. All of the input data provided to the yield prediction model can be used by the model to make predictions, for example for each represented entity, regarding whether the entity is likely to yield to the AV.

At step 608, the process 600 includes evaluating a performance of the planning module of the AV based on the yield projection for each of the one or more entities and the yield prediction for each of the one or more entities. As discussed above with respect to FIG. 2, outputs (or projections) of the planning module can be compared to yield predictions made by the yield prediction model to determine/identify conflicts (e.g., where yield predictions disagree with yield projections of the planning module). In some instances, the planning module may falsely project that a given entity will yield. In other instances the planning module may falsely project that a given entity will not yield (i.e., that it will assert). Performance of the planner may be used to identify instances that can be used for further training of the various heuristics and models used to implement the planning module of the AV software stack.

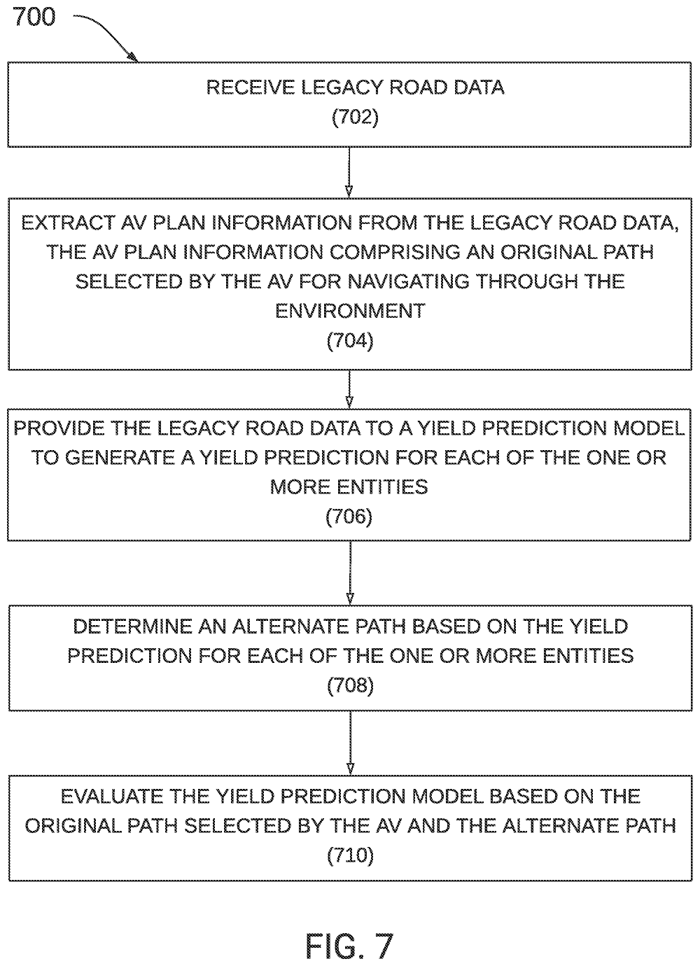

FIG. 7 illustrates an example process 700 for evaluating the performance of a machine-learning model that is configured to generate yield/assert predictions, based on resulting AV behaviors, according to some aspects of the present disclosure. At step 702, process 700 includes receiving legacy road data. The legacy road data can include road data that has been previously collected by one or more AVs, such as one or more AVs in an AV fleet. As discussed above, the (legacy) road data can include sensor data representing various entities that the collecting AV encountered during operation.

At step 704, process 700 includes extracting plan information from the legacy road data, the AV plan information comprising an original path selected by the AV for navigating through the environment. That is, the plan information can represent an original intent for how the corresponding AV will proceed through the environment.

At step 706, process 700 includes providing the legacy road data to a yield prediction model to generate a yield prediction for each of the one or more entities. In some approaches, the legacy road data may be pre-process to extract certain information components that can be consumed by the yield prediction model, such as entity trajectory information, entity history information, AV state information and/or map context information etc.

At step 708, process 700 includes determining an alternate path based on the yield prediction for each of the one or more entities. In some aspects, the alternate path can be based on an updated cost calculation for each path plan, e.g., that is based on yield predictions made by the yield prediction model.

At step 710, process 700 includes evaluating the yield prediction model based on the original path selected by the AV and the alternate path. In some aspects, the alternate path (e.g., the path that is based on cost metrics that include the yield prediction from the yield prediction model) may be different from the original path navigated by the AV. In such instances, use of the yield prediction model would have changed the resulting trajectory/path of the AV. As such, the impact of the yield prediction model on AV behavior can be determined based on how use of the yield prediction model would have affected the AV behavior. Importantly, the impact of the yield prediction model on AV behavior can be evaluated using legacy road data, so that the model can be evaluated without actual deployment into live AV deployments e.g., without adequate testing.

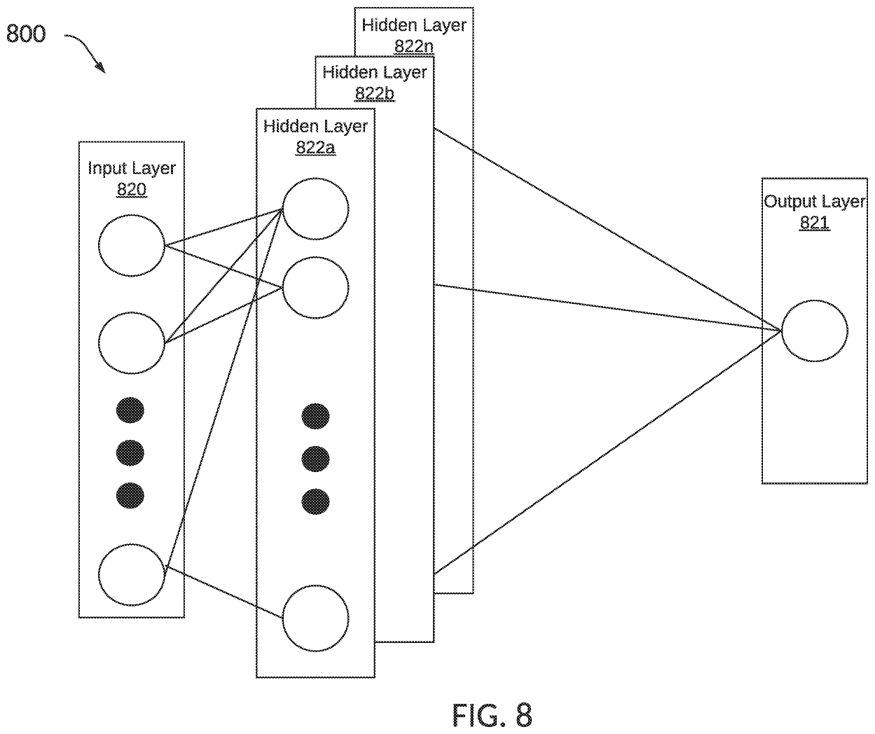

FIG. 8 illustrates an example of a deep learning neural network that can be used to implement an assert/yield prediction model. An input layer 820 can be configured to receive road data relating to an environment surrounding an AV. Neural network 800 includes multiple hidden layers 822a, 822b, through 822n. The hidden layers 822a, 822b, through 822n include “n” number of hidden layers, where “n” is an integer greater than or equal to one. The number of hidden layers can be made to include as many layers as needed for the given application. Neural network 800 further includes an output layer 821 that provides an output resulting from the processing performed by the hidden layers 822a, 822b, through 822n.

The neural network 800 is a multi-layer neural network of interconnected nodes. Each node can represent a piece of information. Information associated with the nodes is shared among the different layers and each layer retains information as information is processed. In some cases, the neural network 800 can include a feed-forward network, in which case there are no feedback connections where outputs of the network are fed back into itself. In some cases, the neural network 800 can include a recurrent neural network, which can have loops that allow information to be carried across nodes while reading in input.

Information can be exchanged between nodes through node-to-node interconnections between the various layers. Nodes of the input layer 820 can activate a set of nodes in the first hidden layer 822a. For example, as shown, each of the input nodes of input layer 820 is connected to each of the nodes of the first hidden layer 822a. The nodes of the first hidden layer 822a can transform the information of each input node by applying activation functions to the input node information. The information derived from the transformation can then be passed to and can activate the nodes of the next hidden layer 822b, which can perform their own designated functions. Example functions include convolutional, up-sampling, data transformation, and/or any other suitable functions. The output of the hidden layer 822b can then activate nodes of the next hidden layer, and so on. The output of the last hidden layer 822n can activate one or more nodes of the output layer 821, at which an output is provided. In some cases, while nodes in the neural network 800 are shown as having multiple output lines, a node can have a single output and all lines shown as being output from a node represent the same output value.

In some cases, each node or interconnection between nodes can have a weight that is a set of parameters derived from the training of the neural network 800. Once the neural network 800 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 800 to be adaptive to inputs and able to learn as more and more data is processed.

The neural network 800 is pre-trained to process the features from the data in the input layer 820 using the different hidden layers 822a, 822b, through 822n in order to provide the output through the output layer 821.

In some cases, the neural network 800 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 800 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(1/2 (target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 800 can perform a backward pass by determining which inputs (weights) most contributed to the loss of the network, and can adjust the weights so that the loss decreases and is eventually minimized.

The neural network 800 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 800 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 9 is a diagram illustrating an example autonomous vehicle (AV) environment 900, according to some examples of the present disclosure. One of ordinary skill in the art will understand that, for the AV environment 900 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 900 includes an AV 902, a data center 950, and a client computing device 970. The AV 902, the data center 950, and the client computing device 970 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 902 can navigate roadways without a human driver based on sensor signals generated by multiple sensor systems 904, 906, and 908. The sensor systems 904-908 can include one or more types of sensors and can be arranged about the AV 902. For instance, the sensor systems 904-908 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 904 can be a camera system, the sensor system 906 can be a LIDAR system, and the sensor system 908 can be a RADAR system. Other examples may include any other number and type of sensors.

The AV 902 can also include several mechanical systems that can be used to maneuver or operate the AV 902. For instance, the mechanical systems can include a vehicle propulsion system 930, a braking system 932, a steering system 934, a safety system 936, and a cabin system 938, among other systems. The vehicle propulsion system 930 can include an electric motor, an internal combustion engine, or both. The braking system 932 can include an engine brake, brake pads, actuators, and/or any other suitable componentry configured to assist in decelerating the AV 902. The steering system 934 can include suitable componentry configured to control the direction of movement of the AV 902 during navigation. The safety system 936 can include lights and signal indicators, a parking brake, airbags, and so forth. The cabin system 938 can include cabin temperature control systems, in-cabin entertainment systems, and so forth. In some examples, the AV 902 might not include human driver actuators (e.g., steering wheel, handbrake, foot brake pedal, foot accelerator pedal, turn signal lever, window wipers, etc.) for controlling the AV 902. Instead, the cabin system 938 can include one or more client interfaces (e.g., Graphical User Interfaces (GUIs), Voice User Interfaces (VUIs), etc.) for controlling certain aspects of the mechanical systems 930-938.

The AV 902 can include a local computing device 910 that is in communication with the sensor systems 904-908, the mechanical systems 930-938, the data center 950, and the client computing device 970, among other systems. The local computing device 910 can include one or more processors and memory, including instructions that can be executed by the one or more processors. The instructions can make up one or more software stacks or components responsible for controlling the AV 902; communicating with the data center 950, the client computing device 970, and other systems; receiving inputs from riders, passengers, and other entities within the AV's environment; logging metrics collected by the sensor systems 904-908; and so forth. In this example, the local computing device 910 includes a perception stack 912, a localization stack 914, a prediction stack 916, a planning stack 918, a communications stack 920, a control stack 922, an AV operational database 924, and an HD geospatial database 926, among other stacks and systems.

The perception stack 912 can enable the AV 902 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 904-908, the localization stack 914, the HD geospatial database 926, other components of the AV, and other data sources (e.g., the data center 950, the client computing device 970, third party data sources, etc.). The perception stack 912 can detect and classify objects and determine their current locations, speeds, directions, and the like. In addition, the perception stack 912 can determine the free space around the AV 902 (e.g., to maintain a safe distance from other objects, change lanes, park the AV, etc.). The perception stack 912 can identify environmental uncertainties, such as where to look for moving objects, flag areas that may be obscured or blocked from view, and so forth. In some examples, an output of the perception stack 912 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The localization stack 914 can determine the AV's position and orientation (pose) using different methods from multiple systems (e.g., GPS, IMUs, cameras, LIDAR, RADAR, ultrasonic sensors, the HD geospatial database 926, etc.). For example, in some cases, the AV 902 can compare sensor data captured in real-time by the sensor systems 904-908 to data in the HD geospatial database 926 to determine its precise (e.g., accurate to the order of a few centimeters or less) position and orientation. The AV 902 can focus its search based on sensor data from one or more first sensor systems (e.g., GPS) by matching sensor data from one or more second sensor systems (e.g., LIDAR). If the mapping and localization information from one system is unavailable, the AV 902 can use mapping and localization information from a redundant system and/or from remote data sources.

The prediction stack 916 can receive information from the localization stack 914 and objects identified by the perception stack 912 and predict a future path for the objects. In some examples, the prediction stack 916 can output several likely paths that an object is predicted to take along with a probability associated with each path. For each predicted path, the prediction stack 916 can also output a range of points along the path corresponding to a predicted location of the object along the path at future time intervals along with an expected error value for each of the points that indicates a probabilistic deviation from that point.

The planning stack 918 can determine how to maneuver or operate the AV 902 safely and efficiently in its environment. For example, the planning stack 918 can receive the location, speed, and direction of the AV 902, geospatial data, data regarding objects sharing the road with the AV 902 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 902 from one point to another and outputs from the perception stack 912, localization stack 914, and prediction stack 916. The planning stack 918 can determine multiple sets of one or more mechanical operations that the AV 902 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 918 can select from multiple backup plans to carry out. For example, while preparing to change lanes to turn right at an intersection, another vehicle may aggressively cut into the destination lane, making the lane change unsafe. The planning stack 918 could have already determined an alternative plan for such an event. Upon its occurrence, it could help direct the AV 902 to go around the block instead of blocking a current lane while waiting for an opening to change lanes.

The control stack 922 can manage the operation of the vehicle propulsion system 930, the braking system 932, the steering system 934, the safety system 936, and the cabin system 938. The control stack 922 can receive sensor signals from the sensor systems 904-908 as well as communicate with other stacks or components of the local computing device 910 or a remote system (e.g., the data center 950) to effectuate operation of the AV 902. For example, the control stack 922 can implement the final path or actions from the multiple paths or actions provided by the planning stack 918. This can involve turning the routes and decisions from the planning stack 918 into commands for the actuators that control the AV's steering, throttle, brake, and drive unit.

The communications stack 920 can transmit and receive signals between the various stacks and other components of the AV 902 and between the AV 902, the data center 950, the client computing device 970, and other remote systems. The communications stack 920 can enable the local computing device 910 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 920 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 926 can store HD maps and related data of the streets upon which the AV 902 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.).

The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 924 can store raw AV data generated by the sensor systems 904-908, stacks 912-922, and other components of the AV 902 and/or data received by the AV 902 from remote systems (e.g., the data center 950, the client computing device 970, etc.). In some examples, the raw AV data can include HD LIDAR point cloud data, image data, RADAR data, GPS data, and other sensor data that the data center 950 can use for creating or updating AV geospatial data or for creating simulations of situations encountered by AV 902 for future testing or training of various machine learning algorithms that are incorporated in the local computing device 910.

The data center 950 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 950 can include one or more computing devices remote to the local computing device 910 for managing a fleet of AVs and AV-related services. For example, in addition to managing the AV 902, the data center 950 may also support a ridehailing service (e.g., a ridesharing service), a delivery service, a remote/roadside assistance service, street services (e.g., street mapping, street patrol, street cleaning, street metering, parking reservation, etc.), and the like.

The data center 950 can send and receive various signals to and from the AV 902 and the client computing device 970. These signals can include sensor data captured by the sensor systems 904-908, roadside assistance requests, software updates, ridehailing/ridesharing pick-up and drop-off instructions, and so forth. In this example, the data center 950 includes a data management platform 952, an Artificial Intelligence/Machine Learning (AI/ML) platform 954, a simulation platform 956, a remote assistance platform 958, and a ridehailing platform 960, and a map management platform 962, among other systems.

The data management platform 952 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridehailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 950 can access data stored by the data management platform 952 to provide their respective services.

The AI/ML platform 954 can provide the infrastructure for training and evaluating machine learning algorithms for operating the AV 902, the simulation platform 956, the remote assistance platform 958, the ridehailing platform 960, the map management platform 962, and other platforms and systems. Using the AI/ML platform 954, data scientists can prepare data sets from the data management platform 952; select, design, and train machine learning models; evaluate, refine, and deploy the models; maintain, monitor, and retrain the models; and so on.

The simulation platform 956 can enable testing and validation of the algorithms, machine learning models, neural networks, and other development efforts for the AV 902, the remote assistance platform 958, the ridehailing platform 960, the map management platform 962, and other platforms and systems. The simulation platform 956 can replicate a variety of driving environments and/or reproduce real-world scenarios from data captured by the AV 902, including rendering geospatial information and road infrastructure (e.g., streets, lanes, crosswalks, traffic lights, stop signs, etc.) obtained from a cartography platform (e.g., map management platform 962); modeling the behavior of other vehicles, bicycles, pedestrians, and other dynamic elements; simulating inclement weather conditions, different traffic scenarios; and so on.

The remote assistance platform 958 can generate and transmit instructions regarding the operation of the AV 902. For example, in response to an output of the AI/ML platform 954 or other system of the data center 950, the remote assistance platform 958 can prepare instructions for one or more stacks or other components of the AV 902.

The ridehailing platform 960 can interact with a customer of a ridehailing service via a ridehailing application 972 executing on the client computing device 970. The client computing device 970 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridehailing application 972. The client computing device 970 can be a customer's mobile computing device or a computing device integrated with the AV 902 (e.g., the local computing device 910). The ridehailing platform 960 can receive requests to pick up or drop off from the ridehailing application 972 and dispatch the AV 902 for the trip.

Map management platform 962 can provide a set of tools for the manipulation and management of geographic and spatial (geospatial) and related attribute data. The data management platform 952 can receive LIDAR point cloud data, image data (e.g., still image, video, etc.), RADAR data, GPS data, and other sensor data (e.g., raw data) from one or more AVs 902, Unmanned Aerial Vehicles (UAVs), satellites, third-party mapping services, and other sources of geospatially referenced data. The raw data can be processed, and map management platform 962 can render base representations (e.g., tiles (2D), bounding volumes (3D), etc.) of the AV geospatial data to enable users to view, query, label, edit, and otherwise interact with the data. Map management platform 962 can manage workflows and tasks for operating on the AV geospatial data. Map management platform 962 can control access to the AV geospatial data, including granting or limiting access to the AV geospatial data based on user-based, role-based, group-based, task-based, and other attribute-based access control mechanisms. Map management platform 962 can provide version control for the AV geospatial data, such as to track specific changes that (human or machine) map editors have made to the data and to revert changes when necessary. Map management platform 962 can administer release management of the AV geospatial data, including distributing suitable iterations of the data to different users, computing devices, AVs, and other consumers of HD maps. Map management platform 962 can provide analytics regarding the AV geospatial data and related data, such as to generate insights relating to the throughput and quality of mapping tasks.

In some embodiments, the map viewing services of map management platform 962 can be modularized and deployed as part of one or more of the platforms and systems of the data center 950. For example, the AI/ML platform 954 may incorporate the map viewing services for visualizing the effectiveness of various object detection or object classification models, the simulation platform 956 may incorporate the map viewing services for recreating and visualizing certain driving scenarios, the remote assistance platform 958 may incorporate the map viewing services for replaying traffic incidents to facilitate and coordinate aid, the ridehailing platform 960 may incorporate the map viewing services into the client application 972 to enable passengers to view the AV 902 in transit en route to a pick-up or drop-off location, and so on.

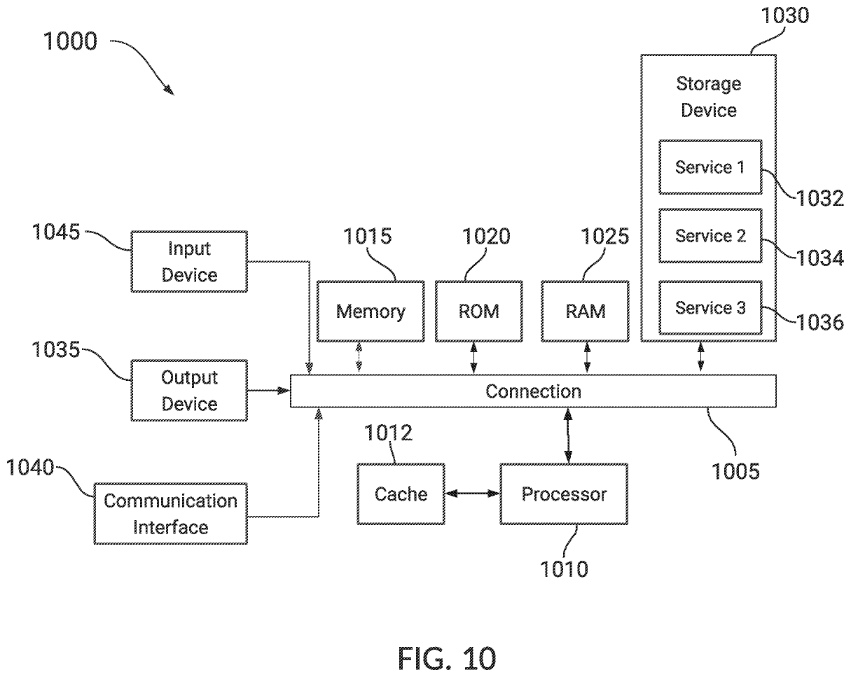

While the autonomous vehicle 902, the local computing device 910, and the autonomous vehicle environment 900 are shown to include certain systems and components, one of ordinary skill will appreciate that the autonomous vehicle 902, the local computing device 910, and/or the autonomous vehicle environment 900 can include more or fewer systems and/or components than those shown in FIG. 9. For example, the autonomous vehicle 902 can include other services than those shown in FIG. 9 and the local computing device 910 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 9. An illustrative example of a computing device and hardware components that can be implemented with the local computing device 910 is described below with respect to FIG. 10.

FIG. 10 illustrates an example processor-based system with which some aspects of the subject technology can be implemented. For example, processor-based system 1000 can be any computing device making up, or any component thereof in which the components of the system are in communication with each other using connection 1005. Connection 1005 can be a physical connection via a bus, or a direct connection into processor 1010, such as in a chipset architecture. Connection 1005 can also be a virtual connection, networked connection, or logical connection.

In some embodiments, computing system 1000 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1000 includes at least one processing unit (Central Processing Unit (CPU) or processor) 1010 and connection 1005 that couples various system components including system memory 1015, such as Read-Only Memory (ROM) 1020 and Random-Access Memory (RAM) 1025 to processor 1010. Computing system 1000 can include a cache of high-speed memory 1012 connected directly with, in close proximity to, or integrated as part of processor 1010.

Processor 1010 can include any general-purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms known to those of skill in the art. In some instances, multimodal systems can enable a user to provide multiple types of input/output to communicate with computing system 1000. Computing system 1000 can include communications interface 1040, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an

IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM

(DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 1030 can include software services, servers, services, etc., that when the code that defines such software is executed by the processor 1010, it causes the system 1000 to perform a function. In some embodiments, a hardware service that performs a particular function can include the software component stored in a computer-readable medium in connection with the necessary hardware components, such as processor 1010, connection 1005, output device 1035, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. An apparatus comprising:
at least one memory; and
at least one processor coupled to the at least one memory, the at least one processor configured to:
receive road data comprising sensor data collected by an autonomous vehicle (AV), the sensor data representing one or more entities encountered by the AV;
extract trajectory data, from the road data, for each of the one or more entities;
provide the trajectory data to a machine-learning (ML) model, wherein the ML model is trained to generate a yield prediction for each of the one or more entities; and
determine a path for the AV based on the yield prediction for each of the one or more entities.

2. The apparatus of claim 1, wherein to determine the path of the AV based on the yield prediction for each of the one or more entities, the at least one processor is further configured to:
compare the yield prediction for each of the one or more entities to one or more path plans generated by a planning module of the AV; and
increase a cost metric associated with any of the one or more path plans that conflict with the yield prediction for each of the one or more entities.

3. The apparatus of claim 2, wherein the at least one processor is further configured to:
select the trajectory for the AV from among the one or more path plans.

4. The apparatus of claim 1, wherein the yield prediction for each of the one or more entities is based on map data.

5. The apparatus of claim 4, wherein the map data comprises traffic light information, lane information, cross walk region information, parting region information, or a combination thereof.

6. The apparatus of claim 1, wherein the yield prediction for each of the one or more entities is based on state information associated with the AV.

7. The apparatus of claim 1, wherein the one or more entities comprises one or more vehicles or pedestrians.

8. A computer-implemented method comprising:
receiving road data comprising sensor data collected by an autonomous vehicle (AV), the sensor data representing one or more entities encountered by the AV;
extracting trajectory data for each of the one or more entities in the environment;
providing the trajectory data to a machine-learning (ML) model, wherein the ML model is trained to generate, based on the trajectory data, a yield prediction for each of the one or more entities; and
determining a trajectory for the AV based on the yield prediction for each of the one or more entities.

9. The method of claim 8, wherein determining a path of the AV based on the yield prediction, further comprises:
comparing the yield prediction for each of the one or more entities to one or more path plans generated by a planning module of the AV; and
increasing a cost metric associated with any of the one or more path plans that conflict with the yield prediction for each of the one or more entities.

10. The method of claim 9, further comprising:
selecting the trajectory for the AV from among the one or more path plans.

11. The method of claim 8, wherein the yield prediction for each of the one or more entities is based on map data.

12. The method of claim 11, wherein the map data comprises traffic light information, lane information, cross walk region information, parting region information, or a combination thereof.

13. The method of claim 8, wherein the yield prediction for each of the one or more entities is based on state information associated with the AV.

14. The method of claim 8, wherein the one or more entities comprises one or more vehicles or pedestrians.

15. A non-transitory computer-readable storage medium comprising at least one instruction for causing a computer or processor to:
receive road data comprising sensor data corresponding with one or more entities in an environment associated with an autonomous vehicle (AV);
extract trajectory data for each of the one or more entities in the environment;
provide the trajectory data to a machine-learning (ML) model, wherein the ML model is trained to generate, based on the trajectory data, a yield prediction for each of the one or more entities; and
determine a trajectory for the AV based on the yield prediction for each of the one or more entities.

16. The non-transitory computer-readable storage medium of claim 15, wherein to determine a path of the AV based on the yield prediction, the at least one instruction is further configured to cause the computer or processor to:
compare the yield prediction for each of the one or more entities to one or more path plans generated by a planning module of the AV; and
increase a cost metric associated with any of the one or more path plans that conflict with the yield prediction for each of the one or more entities.

17. The non-transitory computer-readable storage medium of claim 16, wherein the at least one instruction is further configured to cause the computer or processor to:
select the trajectory for the AV from among the one or more path plans.

18. The non-transitory computer-readable storage medium of claim 15, wherein the yield prediction for each of the one or more entities is based on map data.

19. The non-transitory computer-readable storage medium of claim 18, wherein the map data comprises traffic light information, lane information, cross walk region information, parting region information, or a combination thereof.

20. The non-transitory computer-readable storage medium of claim 15, wherein the yield prediction for each of the one or more entities is based on state information associated with the AV.
